(19) United States
(12) Patent Application Publication
(10) Pub. No.: US 2025/0387977 A1
(43) Pub. Date: Dec. 25, 2025

(54) MEASUREMENT APPARATUS AND METHOD, AND ADDITIVE MANUFACTURING DEVICE

(71) Applicant: SHENZHEN ANYCUBIC TECHNOLOGY CO., LTD., Shenzhen (CN)

(72) Inventor: Ning MA, Shenzhen (CN)

(73) Assignee: SHENZHEN ANYCUBIC TECHNOLOGY CO., LTD., Shenzhen (CN)

(21) Appl. No.: 19/312,349

(22) Filed: Aug. 28, 2025

Related U.S. Application Data
(63) Continuation of application No. PCT/CN2024/078167, filed on Feb. 22, 2024.

(30) Foreign Application Priority Data
Feb. 28, 2023 (CN) 202310227157.7

(51) Int. Cl. B29C 64/393; B29C 64/124; B33Y 30/00; B33Y 50/02

(52) U.S. Cl. CPC B29C 64/393; B29C 64/124; B33Y 50/02; B33Y 30/00

(57) ABSTRACT

A measurement apparatus and method, and an additive manufacturing device are provided. A driving assembly is mainly controlled to drive a probe assembly to come into contact with or be separated from a printing resin to generate a signal, the height of the probe assembly when the signal is generated is acquired from control information, and then the liquid level of the printing resin is determined from the height. The measurement apparatus is mainly used for measuring the remaining amount of a printing resin.

### CROSS REFERENCE TO THE RELATED APPLICATIONS

This application is the continuation application of International Application No. PCT/CN2024/078167, filed on Feb. 22, 2024, which is based upon and claims priority to Chinese Patent Application No. 202310227157.7, filed on Feb. 28, 2023, the entire contents of which are incorporated herein by reference.

### TECHNICAL FIELD

The present application relates to the technical field of additive manufacturing, and in particular to a measurement apparatus and method, and an additive manufacturing device.

### BACKGROUND

In a photo-curing additive manufacturing device, a cartridge containing a printing resin is placed on a base of the device, a lifting mechanism drives a printing platform to be immersed in the printing resin, and the printing resin between the printing platform and a release liner of the cartridge is cured by irradiation of a light source according to a specific shape, The printing platform then rises, the printing resin is filled between a formed model and the release liner for further curing of a next layer, and layers are superposed to form a three-dimensional model. During printing, the liquid printing resin in the cartridge will gradually decrease as a cured and formed volume increases, and when the printing resin is insufficient, the printing will fail.

In common printing resin measurement methods, a measurement component is provided at a level at which the cartridge is fixed. The Patent Application No. CN 100434261C provides a re-coating apparatus for a photo-curing rapid molding process, including a resin tank and a pair of electrodes for measuring a liquid level. The heights of the electrodes relative to the resin tank are fixed. When the electrodes are immersed in the resin and separated from the resin, the conductivities of the two electrodes vary to measure the resin. However, it can only be determined whether a liquid surface of the resin is higher than the electrodes, and the remaining amount of the resin cannot be accurately measured.

### SUMMARY

In view of this, embodiments of the present application provide a measurement apparatus and method, and an additive manufacturing device for solving the problem of inability to accurately measure the remaining amount of a resin.

In order to achieve the above objective, the present application mainly provides the following technical solutions.

In one aspect, the present application provides a measurement apparatus for use in an additive manufacturing device, the measurement apparatus including: a probe assembly including a measurement portion and configured for electrical connection to a processor of the additive manufacturing device, the probe assembly being configured to generate and transmit a signal to the processor when the measurement portion comes into contact with and/or is separated from a printing resin; and a driving assembly configured for electrical connection to the processor of the additive manufacturing device, the probe assembly being also connected to the driving assembly for driving the probe assembly to move under the control of the processor, so as to adjust a height position of the measurement portion; wherein the processor is configured to determine a liquid level of the printing resin from the signal.

In another aspect, the present application further provides an additive manufacturing device, including the measurement apparatus of any one of the preceding embodiments.

In yet another aspect, the present application further provides a measurement method, including: in response to a printing platform moving to a set position, controlling a driving assembly to drive a probe assembly to move along a first path to lower a height of a measurement portion of the probe assembly until a first signal that is generated when the measurement portion comes into contact with the resin is received; and determining a liquid level of the printing resin from the first signal.

In still yet another aspect, the present application further provides an additive manufacturing device, including a processor and a memory storing a computer-executable code, wherein the processor is configured to execute the computer-executable code to implement the aforementioned measurement method.

According to the measurement apparatus and method and the additive manufacturing device according to the embodiments of the present application, the signal is generated mainly by controlling the driving assembly to drive the probe assembly to come into contact with or be separated from the printing resin to obtain the height of the probe assembly at a moment when the signal is generated, and the liquid level of the printing resin is then determined from the height. In the prior art, it is common to provide a measurement component at a level at which a cartridge is fixed, the height of the measurement component relative to a resin tank is fixed, and the resin is measured by immersing and separating the measurement component from the resin. However, it can only be determined whether a liquid surface of the resin is higher than the electrodes, and the remaining amount of the resin cannot be accurately measured. Compared to the prior art, in the present application document, the driving assembly drives the probe assembly toward or away from the printing resin, the measurement portion generates the signal when the measurement portion comes into contact with and/or is separated from the printing resin, the processor determines the height position of the measurement portion of the probe assembly when the signal is received from the movement information of the measurement portion of the probe assembly, and the liquid level of the printing resin can be determined from the height position of the measurement portion, such that the remaining amount of the printing resin can be accurately measured, regardless of the remaining amount of the printing resin.

### BRIEF DESCRIPTION OF THE DRAWINGS

FIG. 1 is a partial structural schematic diagram of a measurement apparatus according to an embodiment of the present application from a first perspective;

FIG. 2 is a partial structural schematic diagram of a measurement apparatus according to an embodiment of the present application from a second perspective;

FIG. 3 is a partial structural schematic diagram of another measurement apparatus according to an embodiment of the present application from a first perspective;

FIG. 4 is a partial structural schematic diagram of another measurement apparatus according to an embodiment of the present application from a second perspective;

FIG. 5 is a schematic view of a measurement apparatus measuring a printing resin at a first liquid level according to an embodiment of the present application;

FIG. 6 is a schematic view of a measurement apparatus measuring a printing resin at a second liquid level according to an embodiment of the present application;

FIG. 7 is a partial structural block view of a measurement apparatus according to an embodiment of the present application;

FIG. 8 is a schematic circuit diagram of a probing circuit of a measurement apparatus according to an embodiment of the present application;

FIG. 9 is a schematic circuit diagram of a level shifting circuit and a driving circuit of a measurement apparatus according to an embodiment of the present application;

FIG. 10 is a schematic circuit diagram of a current measurement module of a measurement apparatus according to an embodiment of the present application;

FIG. 11 is a schematic circuit diagram of a data acquisition module of a measurement apparatus according to an embodiment of the present application;

FIG. 12 is a schematic circuit diagram of an indicator light module of a measurement apparatus according to an embodiment of the present application;

FIG. 13 is a schematic circuit diagram of a connecting module of a measurement apparatus connected to a processor according to an embodiment of the present application;

FIG. 14 is a flow chart of a measurement method according to an embodiment of the present application; and

FIG. 15 is a flow chart of another measurement method according to an embodiment of the present application.

### DETAILED DESCRIPTION OF THE EMBODIMENTS

In order to further illustrate the technical means used to achieve an intended purpose of the present application and the technical effects of the present application, specific implementations, the structure, features and effects of a measurement apparatus according to the present application are described in detail below with reference to the accompanying drawings and preferred embodiments.

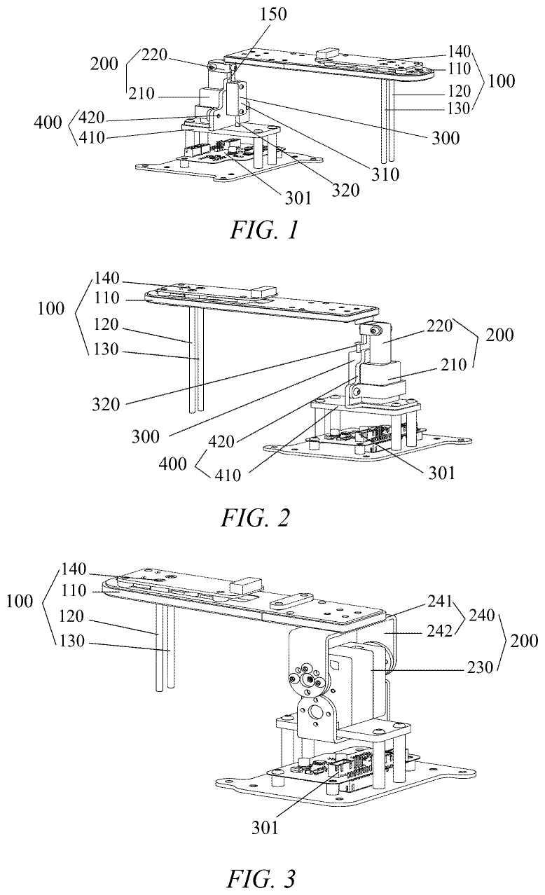

In one aspect, as shown in FIGS. 1-7, embodiments of the present application the present application provide a measurement apparatus for use in an additive manufacturing device, the measurement apparatus including:
a probe assembly 100 including a measurement portion and configured for electrical connection to a processor 500 of the additive manufacturing device, the probe assembly 100 being configured to generate and transmit a signal to the processor 500 when coming into contact with and/or being separated from a printing resin; and
a driving assembly 200 configured for electrical connection to the processor 500 of the additive manufacturing device, the probe assembly 100 being also connected to the driving assembly 200 for driving the probe assembly 100 to move under the control of the processor 500, so as to adjust a height position of the measurement portion.

The processor 500 determines a liquid level of the printing resin from the signal.

The photo-curing additive manufacturing device typically includes a base and a resin vat 10, wherein the base typically includes an accommodating cavity and a top plate at a top end of the accommodating cavity. A light-transmitting opening is provided in the top plate and a display screen is provided at the light-transmitting opening. The resin vat 10 is configured to contain the printing resin and is placed on the top plate opposite and in fit with the display screen. The accommodating cavity is configured to accommodate a light source, and light rays from the light source are projected onto the display screen and pass through the display screen and a release liner of the resin vat 10 onto the printing resin, curing the printing resin. The driving assembly 200 may be disposed at a plurality of positions on the base, such as may be connected to the top plate, on one side of the resin vat 10, or may be connected to side walls of the base. The driving assembly 200 is configured to drive the probe assembly 100 to move toward or away from the printing resin under the control of the processor 500, with an intention to allow the probe assembly 100 to change from a state of contact with the printing resin to a state of separation from the printing resin during movement, or allow the probe assembly 100 to change from the state of separation from the printing resin to the state of contact with the printing resin during movement. Since the resin vat 10 is placed horizontally, the height position of the measurement portion can be adjusted by moving in a vertical direction, by rotating, or the like, such as by moving the probe assembly 100 in the vertical direction. Alternatively, in some other implementations, it is also possible to rotate the probe assembly 100 such that the measurement portion of the probe assembly 100 has a displacement component in the vertical direction. Two types of movements of the probe assembly 100 will be described in detail below.

The probe assembly 100 can include a variety of probing apparatuses intended to generate a measurement signal at a moment when the probe assembly comes into contact with or is separated from the printing resin. In an implementation, the probe assembly 100 includes a connecting plate 110, a first probing component 120, a second probing component 130, and a main board 140. A first end of the connecting plate 110 is connected to the driving assembly 200, and a second end of the connecting plate 110 extends toward a side away from the driving assembly 200, i.e., toward a position above the resin vat 10. The first probing component 120 and the second probing component 130 may be elongated electrically conductive probes. The main board 140 is disposed on the connecting plate 110, one end of the first probing component 120 and one end of the second probing component 130 are each connected to the main board 140, the main board 140 is integrated with a probing circuit, and the first probing component 120 and the second probing component 130 are electrically connected to the processor 500 by the probing circuit. The other end of the first probing component 120 and the other end of the second probing component 130 extend toward the printing resin, or in a direction away from the connecting plate 110. The measurement portion includes an end of the first probing component 120 away from the connecting plate 110 and an end of the second probing component 130 away from the connecting plate 110. When the driving assembly 200 drives the first probing component 120 and the second probing component 130 down, the first probing component 120 and the second probing component 130 will change from an electrically disconnected state in which the probing components are separated from the printing resin to an electrically connected state in which the probing components are in contact with the printing resin. When the driving assembly 200 drives the first probing component 120 and the second probing component 130 up, the first probing component 120 and the second probing component 130 will change from the electrically connected state in which the probing components are in contact with the printing resin to the electrically disconnected state in which the probing components are separated from the printing resin. The probing circuit will generate a signal when the electrical state of the first probing component 120 and the second probing component 130 changes. It will be understood that a bottom end of the first probing component 120 and a bottom end of the second probing component 130 are in critical contact with a liquid surface of the printing resin at the moment when the signal is generated.

The processor 500 controls the driving assembly 200 by means of a control program. For example, in an implementation in which the driving assembly 200 includes a servo actuator, the processor 500 drives the probe assembly 100 to move by controlling the servo actuator. Control information of the processor 500 includes movement information of an output end of the servo actuator, for example, may include an angle of rotation or a movement distance of the output end of the servo actuator in the vertical direction, and a height of the probe assembly 100 can be thus obtained. For example, an initial position of the probe assembly 100 is set in the processor 500, the control information is the number of rotations of the servo actuator from which the distance the probe assembly 100 moves can be determined, and an actual height of the probe assembly 100 can be thus calculated. Upon receiving the signal, a real-time height of the probe assembly 100 is acquired, and may be a height of the connecting plate 110, and a height of the measurement portion can be obtained from a difference between the height of the connecting plate 110 and a height of the first probing component 120 or the second probing component 130, and an actual liquid level of the printing resin can be thus obtained. In some implementations, the position of the measurement portion when abutting against the release liner or being spaced from the release liner by a certain gap may be stored in the processor 500 as a lowest measurement position, and the initial position also is a zero position. In addition, it is possible to store the position of the measurement portion at the same height as the highest level for a resin capacity may be stored in the processor 500 as the highest measurement position.

The measurement apparatus can be used in a variety of scenarios, such as measuring the amount of addition of the printing resin after the printing resin is added or measuring the remaining amount of the printing resin in real time during printing, and giving an alarm until the remaining amount is less than a preset value, such as less than 30% of the printing resin capacity. In a more specific implementation, before the printing begins, the first probing component 120 and the second probing component 130 are moved to the highest position to pour the printing resin into the resin vat 10, and the printing can begin until the probe assembly 100 generates a signal indicating that the printing resin has been added to the highest level for the resin capacity. During printing, the printing resin is gradually consumed, causing the liquid surface to drop. Every four minutes, the driving assembly 200 drives the probe assembly 100 to move down until the signal is generated, to determine the liquid level of the printing resin at this measurement time. This cycle repeats continuously, and an alarm is given until the liquid level falls to 30% of the highest level for the resin capacity.

According to the measurement apparatus and method and the additive manufacturing device according to the embodiments of the present application, the signal is generated mainly by controlling the driving assembly to drive the probe assembly to come into contact with or be separated from the printing resin, the height of the probe assembly when the signal is generated is obtained from the control information, and the liquid level of the printing resin is then determined from the height. In the prior art, it is common to provide a measurement component at a level at which a cartridge is fixed, the height of the measurement component relative to a resin tank is fixed, and the resin is measured by immersing and separating the measurement component from the resin. However, it can only be determined whether a liquid surface of the resin is higher than the electrodes, and the remaining amount of the resin cannot be accurately measured. Compared to the prior art, in the present application document, the driving assembly drives the probe assembly toward or away from the printing resin, the measurement portion generates the signal when the measurement portion comes into contact with and/or is separated from the printing resin, the processor determines the height position of the probe assembly when the signal is received from the control information for the driving assembly, and the liquid level of the printing resin can be determined from the height position, such that the remaining amount of the printing resin can be accurately measured, regardless of the remaining amount of the printing resin.

The driving assembly 200 may drive the probe assembly 100 to move in the vertical direction, or drive the probe assembly 100 to rotate, as will be described by way of example in two specific configurations, respectively.

First, as shown in FIGS. 1-2, the driving assembly 200 includes a first power component 210, and the first power component 210 is drivingly connected to the probe assembly 100. The first power component 210 is configured to drive the probe assembly 100 to move linearly in the vertical direction.

The first power component 210 may be a linear servo actuator, an output end of the servo actuator is disposed upward, and the servo actuator operates to move the output end vertically. The driving assembly 200 further includes a lifting frame 220. The first power component 210 is connected to the additive manufacturing device. The lifting frame 220 is drivingly connected to the first power component 210, and the probe assembly 100 is connected to the lifting frame 220. The lifting frame 220 moves in the vertical direction, which in turn causes the probe assembly 100 to move in the vertical direction. The movement distance in the vertical direction may be obtained from the control information, and the height of the probe assembly 100 is thus determined. The linear servo actuator converts an electrical pulse signal into a linear displacement. Upon receiving the pulse signal, a driver of the linear servo actuator drives the linear servo actuator to move a fixed linear distance in a set direction. Therefore, in an implementation, the processor 500 may calculate the movement distance of the probe assembly 100 from the number of pulses received by the linear servo actuator from the start of movement of the probe assembly 100 to the time when the signal is generated. For example, the linear servo actuator receives a control signal of 500-2500 us (0-360° rotation) that has a period of 20 mS with a midpoint at 1500 uS, and the control signal sent to the servo actuator each time is a 10 uS adjustment signal, such that the servo actuator drives the probe assembly 100 to move vertically by 0.1 mm. The movement distance may be obtained by acquiring the number of pulses that drive the linear servo actuator from the start of movement of the probe assembly 100 to the time when the signal is generated. Alternatively, in some other implementations, the linear servo actuator includes an encoder. The processor 500 is electrically connected to the encoder. Changes in a code value of the encoder are acquired from the start of movement of the probe assembly 100 to the time when the signal is generated, and the movement distance of the probe assembly 100 is calculated from the changes in the code value. For example, in an implementation, one code is equal to 0.05 mm.

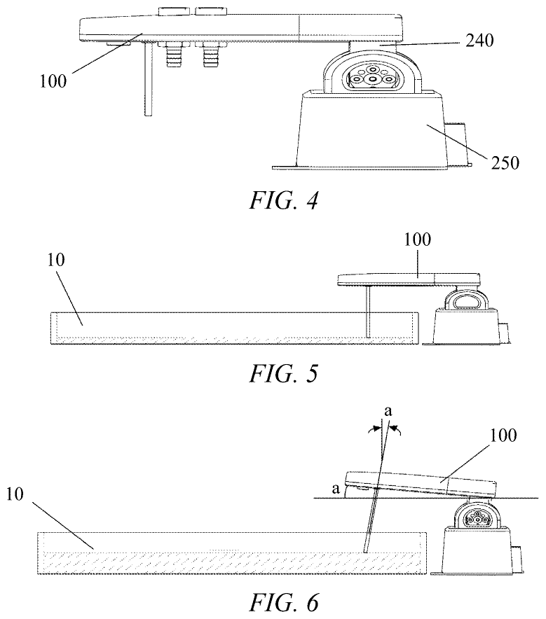

Second, as shown in FIGS. 3-4, the driving assembly 200 includes a second power component 230. The second power component 230 is drivingly connected to the probe assembly 100. The second power component 230 is configured to drive the probe assembly 100 to rotate to adjust the height of the measurement portion.

The second power component 230 may be a rotary servo actuator that includes two side rotating shafts. The two side rotating shafts rotate coaxially and synchronously. Alternatively, the servo actuator includes one rotating shaft. Two ends of the rotating shaft protrude from opposite sides of a housing of the rotary servo actuator. The driving assembly 200 further includes a swing frame 240. The swing frame 240 includes a swing plate 241 and two swing arms 242 connected at two ends of the swing plate 241. The swing plate 241 is connected perpendicularly to the two swing arms 242, such that the swing plate 241 and the two swing arms 242 form an approximately U-shaped frame structure. The two swing arms 242 are connected to the rotating shafts on two sides of the servo actuator. The driving assembly 200 further includes a casing 250. The casing 250 includes two movable openings, and the second power component 230 is located inside the casing. The two swing arms 242 are movably disposed through the two movable openings. The swing plate 241 is configured to be connected to one end of the probe assembly 100. The end of the probe assembly 100 that is provided with the first probing component 120 and the second probing component 130 extends in a direction away from the second power component 230. The servo actuator operates to rotate the rotating shaft, and the swing frame 240 rotates about the rotating shaft, which in turn causes the probe assembly 100 to rotate. As shown in FIGS. 5-6, when the liquid surface of the printing resin in the resin vat 10 is low and the probe assembly 100 sends a measurement signal, the first probing component 120 and the second probing component 130 are nearly in a vertical state. When the liquid surface of the printing resin in the resin vat 10 rises and the probe assembly 100 sends a measurement signal, the first probing component 120 and the second probing component 130 are tilted by rotation. An angle of rotation of the probe assembly 100 and thus the movement distance of the first probing component 120 or the second probing component 130 in the vertical direction can be obtained from the control information, and the height of the probe assembly 100 is thus determined. The rotary servo actuator converts the electrical pulse signal into an angular displacement. Upon receiving the pulse signal, a driver of the rotary servo actuator drives the rotary servo actuator to rotate by a fixed angle called a “step angle” in the set direction. Thus, in an implementation, the processor 500 may calculate the angle of rotation of the probe assembly 100 from the number of pulses received by the rotary servo actuator from the start of movement of the probe assembly 100 to the time when the signal is generated. For example, the control signal sent to the servo actuator each time is a 10 uS adjustment signal such that the servo actuator drives the probe assembly 100 to rotate 0.5°, and the angle of rotation can be obtained from the number of adjustment signals sent.

Alternatively, the rotary servo actuator includes an encoder. The processor 500 is electrically connected to the encoder. Changes in a code value of the encoder are acquired from the start of movement of the probe assembly 100 to the time when the signal is generated, and the angle of rotation of the probe assembly 100 is calculated from the changes in the code value of the encoder. For example, in an implementation, one code is equal to 0.1°.

Alternatively, it is also possible to provide the rotary servo actuator with a rotation measurement component. The rotation measurement component is a combination of a magnetic scale and a magnetic reader. The magnetic scale is disposed on an output rotating shaft of the rotary servo actuator, the magnetic reader corresponds to the magnetic scale. NS-SN-NS poles of the magnetic scale generate different magnetic fields. The magnetic scale will rotate following the output rotating shaft of the rotary servo actuator during the rotation of the probe assembly 100 driven by the rotary servo actuator. The magnetic reader determines the rotation of the output rotating shaft of the rotary servo actuator by sensing the magnetic field of the magnetic scale, and the angle of rotation of the probe assembly 100 is thus obtained.

In a more specific embodiment, as shown in FIG. 6, a start position of the first probing component 120 is a vertical position, and an included angle between a line connecting the measurement portion of the first probing component 120 and a center of rotation and a horizontal plane is 30°. A distance from the measurement portion of the first probing component 120 to the center of rotation is 60 mm, and a vertical distance from the measurement portion to the center of rotation in a horizontal direction is 30 mm. The angle of rotation of the probe assembly 100 is obtained from the control information, and then an included angle a (such as 10°) between the first probing component 120 and the horizontal direction may be determined, and an included angle between the line connecting the measurement portion of the first probing component 120 and the center of rotation and the horizontal plane is 30° minus 10°, i.e., 20°. From the vertical distance from the measurement portion to the center of rotation of 60 mm, the vertical distance from the measurement portion to the center of rotation in the horizontal direction may be determined to be 20.52 mm, and a difference of 19.48 mm between 30 mm and 20.52 mm is a movement height of the measurement portion.

In some other implementations, it is also possible to determine a first movement distance from the angle of rotation and preset parameters. For example, correlation information between the movement distance and the angle of rotation of the measurement portion may be directly stored in the processor 500 by ranges. For example, a range of angles of rotation correspond to a piece of distance information. The angle of rotation that is acquired may directly correspond to the distance information, i.e., obtaining an approximate height position of the probe assembly 100. Although there may be some error (due to a range of angle of rotations corresponding to the same position information), the remaining amount of the printing resin can be estimated, and the calculation by the processor can be significantly simplified.

In an implementation, as shown in FIGS. 1-2, the measurement apparatus further includes: a position measurement component 300 electrically connected to the processor 500, wherein the position measurement component 300 is configured to measure position information of the probe assembly 100 and transmitting the position information to the processor 500, such that the processor 500 determines the liquid level of the printing resin from the signal and the position information; and a base 400. The base 400 is configured for connection to the additive manufacturing device, and both of the driving assembly 200 and the position measurement component 300 are connected to the base 400.

The position measurement component 300 is configured to measure the position information of the probe assembly 100, and measuring the position information may include determining the position by measuring the movement distance of the probe assembly 100, or may include measuring the angle of rotation of the probe assembly 100, which thus allows to calculate the position from the angle of rotation, such that the measurement is more accurate, and the problem of inaccuracies in calculating the height of probe assembly 100 caused by factors such as mechanical errors of the servo actuator in implementations in which control parameters of the servo actuator are obtained for calculation. The position measurement component 300 may be an infrared linear displacement sensor, an infrared range sensor, an angle sensor, etc. The displacement sensor can have a test repetition accuracy of up to 0.01 mm. The measurement is accurate. The processor 500 generates the signal by controlling the driving assembly to drive the probe assembly 100 to come into contact with or be separated from the printing resin, acquire the position information of the probe assembly when the signal is generated by means of the position measurement component 300, and then determines the liquid level of the printing resin from the position information.

More specifically, in implementations in which the processor 500 controls the driving assembly 200 to drive the probe assembly 100 to move in the vertical direction, the probe assembly 100 moves linearly in the vertical direction, the position information may be a movement distance, and the processor 500 can determine the height of the probe assembly 100 from the movement distance and the initial position. Alternatively, in implementations in which the processor 500 controls the driving assembly 200 to drive the probe assembly 100 to rotate, the position information may be an angle of rotation, the movement distance in the vertical direction is calculated from the angle of rotation, and the height of the probe assembly 100 can then be determined. When the first power component 210, i.e., the linear servo actuator, is included, the movement distance in the vertical direction can be determined by the position measurement component 300, and the position information of the probe assembly 100 is then determined. The position measurement component 300 can measure the movement distance in real time, and in the presence of a signal, the total movement distance of the probe assembly 100 can be obtained, and the position information of the probe assembly 100 can thus be determined. When the second power component 230, i.e., the rotary servo actuator, is included, the position measurement component 300 may be an angle of rotation measurement apparatus, such as an angle sensor, mounted on the second power component 230 to measure angle information of the probe assembly 100 that is driven to rotate by the second power component 230. The position measurement component 300 can measure the angle of rotation of the probe assembly 100 in real time, and then calculate the total angle of rotation of the probe assembly 100 in the presence of the signal, to determine the position information of the probe assembly 100.

The driving assembly 200 is connected to the base 400, and the driving assembly 200 includes the first power component 210 or the second power component 230 as described previously. Here, the first power component 210 is taken as an example. Both of the position measurement component 300 and the first power component 210 are disposed on the base 400. The base 400 includes a support frame 410 and a fixing plate 420. The fixing plate 420 is connected to the support frame 410, and the fixing plate 420 is perpendicular to the support frame 410. The first power component 210 is connected to the fixing plate 420, the output end of the first power component 210 protrudes from a top end of the fixing plate 420, and the probe assembly 100 is connected to the output end. The position measurement component 300 is fixed to a side of the fixing plate 420 away from the driving assembly 200 and is located below the probe assembly 100. The support frame 410 may specifically include a top plate, a bottom plate, and support posts. The support posts are located between the top plate and the bottom plate such that an accommodating space is formed between the top plate and the bottom plate. The measurement apparatus further includes a measurement circuit board 301. The measurement circuit board 301 is located in the accommodating space. The measurement circuit board 301 is electrically connected to each of the position measurement component 300, the first power component 210 or the second power component 230 and the processor 500, to relay a signal from the position measurement component 300 and control the first power component 210 or the second power component 230. The support frame 410 accommodates the measurement circuit board 301 such that the measurement apparatus has a more compact structure. The measurement circuit board 301 is also electrically connected to the processor 500 to transmit a measurement signal to the processor 500. The fixing plate 420 makes the positions of the first power component 210 and the position measurement component 300 more stable, and the position measurement component 300 is located closer to the first power component 210, making the measurement of the height of the probe assembly 100 more accurate and preventing inaccurate measurements caused by tilting, deformation, etc. after long-term use.

In an implementation, the position measurement component 300 is a displacement sensor. The displacement sensor includes a sensor body 310 and a measurement head 320 movably connected to the sensor body 310. One of the base 400 and the probe assembly 100 is connected to the sensor body 310, and the other thereof is configured for contact with the measurement head 320 to push the measurement head 320 to move relative to the sensor body 310 to generate the position information.

It is possible for the probe assembly 100 to move. The sensor body 310 is connected to base 400 and remains stationary, the measurement head 320 faces upward and is opposite to the probe assembly 100, and the probe assembly 100 pushes the measurement head 320. It is also possible for the measurement head 320 to face downward and be opposite to the base 400, the sensor body 310 follow the probe assembly 100, the base 400 is stationary, and the base 400 pushes measurement head 320. The probe assembly 100 may be in direct contact with the measurement head 320, or the probe assembly 100 further includes an extension plate 150. The extension plate 150 has one end connected to the connecting plate 110 and the other end extending toward the measurement head 320. The lifting frame 220 is connected to the probe assembly 100 by the extension plate 150. The displacement sensor is configured to convert a vertical displacement of the extension plate 150 into a voltage signal, i.e., a movement signal, which is then converted by a data acquisition module 900 to obtain a digital signal, i.e., the position information. The implementations of the data acquisition module 900 will be described in detail below. In an implementation, a potentiometer is provided in the sensor body 310, and the measurement head 320 is a brush. When the brush is pushed by the extension plate 150, the potentiometer outputs a voltage signal associated with a movement of the brush, and movement distance information can be then obtained.

In an implementation, the measurement portion of the probe assembly 100 includes a lowest measurement position, i.e., the aforementioned initial position or the zero position. When the measurement portion of the probe assembly 100 is in the lowest measurement position, the probe assembly 100 abuts against a top end of the sensor body 310 or the measurement head 320 abuts against the support frame 410, and the measurement portion of the probe assembly 100 abuts against or has a gap with a bottom end of the resin vat of the additive manufacturing device. The resin vat is configured to contain the printing resin.

As shown in FIG. 1, in an implementation in which the extension plate 150 is included, a bottom end of the extension plate 150 is bent to form a contact surface. When the contact surface of the bottom end of the extension plate 150 pushes the measurement head 320 to move to the bottommost end, that is, when the extension plate 150 abuts against the top end of the sensor body 310, the measurement portion of the probe assembly 100 reaches the lowest measurement position, at which point, the bottom ends of the first probing component 120 and the second probing component 130 may be at a distance of 0.3 mm from a bottom surface of the base 400. Since the release liner typically has a thickness of 0.15-0.3 mm, the measurement portion abuts against the release liner or is spaced from the release liner by a small gap when the measurement portion of the probe assembly 100 reaches the lowest measurement position. The extension plate 150 abuts against the top end of the sensor body 310 to prevent the measurement portion from pressing the release liner and causing damage to the release liner. During measurement, when the extension plate 150 abuts against the top end of the sensor body 310, a current of the first power component 210 will rise sharply, and monitoring can be achieved by means of current measurement. A current measurement module will be described in detail later. In another embodiment, when the measurement head 320 abuts against the support frame 410 and abuts down against the support frame 410, the measurement portion of the probe assembly 100 reaches the lowest measurement position.

In an implementation, as shown in FIG. 8, the probe assembly 100 further includes a probing circuit. Both of the first probing component 120 and the second probing component 130 are electrically connected to the probing circuit, and the probing circuit is electrically connected to the processor 500. The probing circuit includes a fourth resistor R4 and a fifth resistor R5. A first end of the fourth resistor R4 is configured for electrical connection to a power supply module of the additive manufacturing device, a second end of the fourth resistor R4 is electrically connected to a first end of the fifth resistor R5, and a second end of the fifth resistor R5 is grounded. The first end of the fifth resistor R5 is also electrically connected to the first probing component 120, the second end of the fifth resistor R5 is also electrically connected to the second probing component 130, and the first end of the fifth resistor R5 is electrically connected to the processor 500.

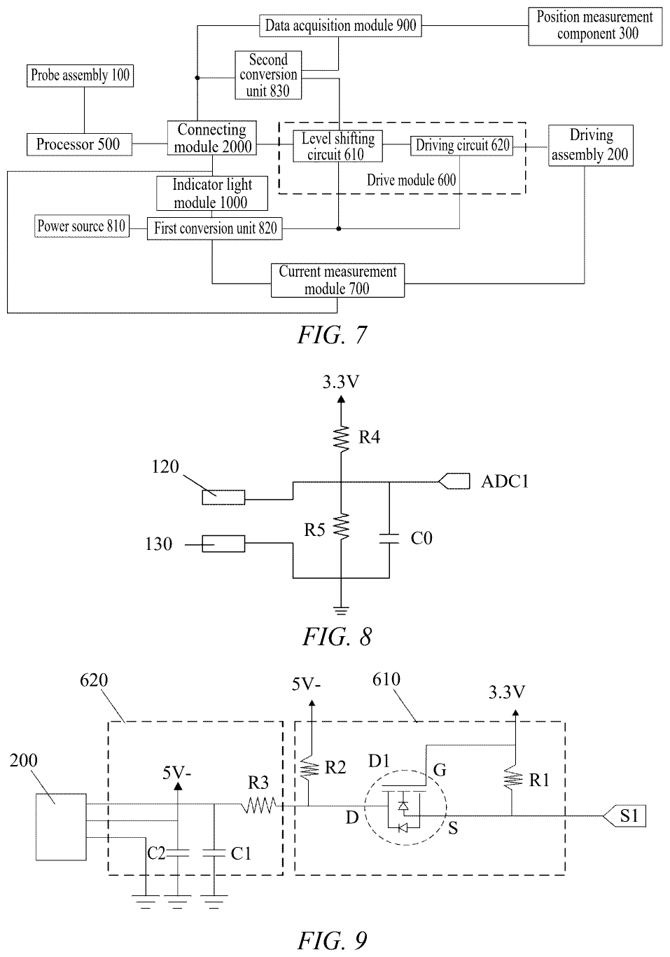

As shown in FIG. 7, the power supply module specifically includes a power source 810, a first conversion unit 820, and a second conversion unit 830. The power source 810 is electrically connected to the first conversion unit 820, the first conversion unit 820 is configured to provide a 5V level for the servo actuator and devices in a circuit that require a 5V level. The second conversion unit 830 is electrically connected to the processor 500, the second conversion unit 830 is configured to provide a 3.3V level for devices in a circuit, such as the probing circuit, which require a 3.3V level, and the power source 810 provides a 24V raw voltage. The first conversion unit 820 and the second conversion unit 830 can be implemented with a variety of conversion chips, such as high-frequency step-down switching regulator, whose specific circuit structure is not limited in the present application, and it is possible to use a general conversion method in the art. When the first probing component 120 and the second probing component 130 are separated and electrically disconnected from the printing resin, the fifth resistor R5 and the fourth resistor R4 will form a series circuit, a voltage division for the fifth resistor R5 increases, and a high level is output by the first end of the fifth resistor R5. When the first probing component 120 and the second probing component 130 are electrically conductive in contact with the printing resin, two ends of the fifth resistor R5 will be connected in parallel to a resistor formed by the first probing component 120, the second probing component 130 and the printing resin, the voltage division for the fifth resistor R5 is reduced, and a low level is output by the first end of the fifth resistor R5. The transition of the output from the high level to the low level triggers the generation of a measurement signal. It may be understood that the measurement signal can also be the transition from the low level to the high level. As long as there is a level shift, the measurement signal is generated. The probing circuit further includes a filter capacitor CO for filtering an output signal at the first end of the fifth resistor R5.

In an implementation, as shown in FIGS. 7 and 9, the measurement apparatus further includes a drive module 600. The processor 500 is electrically connected to the drive module 600, and the drive module 600 is electrically connected to the driving assembly 200. The processor 500 is configured to control the driving assembly 200 to drive the probe assembly 100 to move by means of the drive module 600. The drive module 600 includes a level shifting circuit 610. An input end of the level shifting circuit 610 is electrically connected to the processor 500, and an output end of the level shifting circuit 610 is electrically connected to the driving assembly 200. The level shifting circuit 610 is configured to perform level shifting on a first control signal sent by the processor 500 to generate a second control signal for controlling the driving assembly 200. The level shifting circuit 610 includes a first switch D1, a first resistor R1, and a second resistor R2. A first end of the first switch DI is electrically connected to the processor 500 and a first end of the first resistor R1. A second end of the first switch D1 is electrically connected to a first end of the second resistor R2 and the driving assembly 200. A second end of the second resistor R2 is configured for electrical connection to the power supply module of the additive manufacturing device. A control end of the first switch D1 is electrically connected to the power supply module and a second end of the first resistor R1.

When the first power component 210 or the second power component 230 is a servo actuator, a voltage of the control signal for the servo actuator needs to be 5V in order to control the operation of the servo actuator, and the control signal output by the processor 500, i.e., the first control signal, is a 3.3V signal. The level shifting circuit 610 is configured to shift the 3.3V first control signal into a 5V second control signal to control the operation of the servo actuators so as to move the probe assembly 100. The first switch D1 may be a transistor, such as an NPN-type transistor, a PNP-type transistor, an N-channel MOS transistor, or a P-channel MOS transistor. A fourth switch D4 may be a single transistor or a combination of a plurality of transistors. In an implementation, an N-channel enhancement MOS transistor NMOS is used for the first switch D1. A gate G of the first switch D1 is electrically connected to an output end of the second conversion unit 830, i.e., connected to a 3.3V power supply. A source S of the fourth switch D4 is electrically connected to the processor 500. Two ends of the first resistor R1 are electrically connected to the gate G and a source S of the first switch D1, respectively. A drain D of the first switch D1 is electrically connected to a output end of the first conversion unit 820 by means of the second resistor R2, i.e., connected to a 5V power supply. The drain D of the first switch D1 is also electrically connected to the driving assembly 200. Both of the first resistor R1 and the second resistor R2 are pull-up resistors. When the processor 500 outputs a high level of 3.3V, there will be no voltage difference between the gate G and the source S of the first switch D1, the first switch D1 is switched off, and the drain D of the first switch D1 outputs a high level of 5V. When an output from the processor 500 is at a low level, an on-voltage is generated between the gate G and the source S of the first switch D1, the first switch D1 is switched on, the voltage of the drain D of the first switch D1 is pulled low, and an output from the drain D of the first switch D1 is at a low level, which in turn converts the 3.3V first control signal of the processor 500 into a 5V second control signal.

In an implementation, the drive module 600 further includes a driving circuit 620. A first end of the driving circuit 620 is electrically connected to the output end of the level shifting circuit 610, and a second end of the driving circuit 620 is electrically connected to the driving assembly 200. The driving circuit includes a third resistor R3, a first capacitor C1, and a second capacitor C2. A first end of the third resistor R3 is electrically connected to the output end of the level shifting circuit 610, and a second end of the third resistor R3 is electrically connected to the driving assembly 200. A first end of the first capacitor C1 is electrically connected to the second end of the third resistor R3, and a second end of the first capacitor C1 is grounded. A power supply end of the driving assembly 200 is electrically connected to each of a first end of the second capacitor C2 and the power supply module, and a second end of the second capacitor C2 is grounded.

The first end of the third resistor R3 is electrically connected to the drain D of the first switch D1. The second control signal is filtered by the first capacitor C1 and then is transmitted to a control end of the servo actuator. The servo actuator has a supply voltage of 5V, and a power supply end of the servo actuator is electrically connected to the output end of the first conversion unit 820 of the power supply module. The output end of the first conversion unit 820 is configured to provide a 5V level to the servo actuator. The power supply end of the servo actuator is also connected to the second capacitor C2, and the second capacitor C2 is configured for filtering.

To monitor whether the extension plate 150 is lowered into abutment against the top end of the sensor body 310, the measurement apparatus further includes a current measurement module 700. As shown in FIGS. 7 and 10, an input end of the current measurement module 700 is electrically connected to the power supply module, a first output end of the current measurement module 700 is electrically connected to the power supply end of the driving assembly 200, and a second output end of the current measurement module 700 is electrically connected to the processor 500. The current measurement module 700 is configured to measure a supply current from the driving assembly 200 and generate a movement-stop signal when the supply current is greater than a preset current. The processor 500 is configured to control the driving assembly 200 to stop moving according to the movement-stop signal.

The current measurement module 700 may be a current measurement circuit. The current measurement module 700 includes a first chip U1, a third capacitor C3, and a fourth capacitor C4. Input ends IP+pin and IP−pin of the first chip U1 are each electrically connected to the first conversion unit 820 of the power supply module. A first output end VCC pin of the first chip U1 is electrically connected to a first end of the third capacitor C3 and the power supply end of the driving assembly 200 for outputting 5V power to the servo actuator. A second end of the third capacitor C3 is grounded. The third capacitor C3 is a filter capacitor. A second output end VIOUT pin of the first chip U1 is electrically connected to a first end of the fourth capacitor C4 and the processor 500. A second end of the fourth capacitor C4 is grounded. The fourth capacitor C4 is a filter capacitor. The first chip U1 is configured to measure the magnitude of a current flowing through the first chip U1. When the current is greater than a rated current, an alarm signal is generated and sent to the processor 500 through a second output end VIOUT pin of the first chip U1, and the processor then controls the servo actuator to stop operating. The current being greater than the rated current may mean that the extension plate 150 abuts against the top end of the sensor body 310, which resulting in a sharp rise in the current of the first power component 210, or mean that the probe assembly 100 or the measurement portion abuts against the bottommost end of the resin vat 10, that is to say the lowest position in which the probe assembly 100 can be moved. This serves the functions of determination and monitoring to avoid damage to the probe assembly 100.

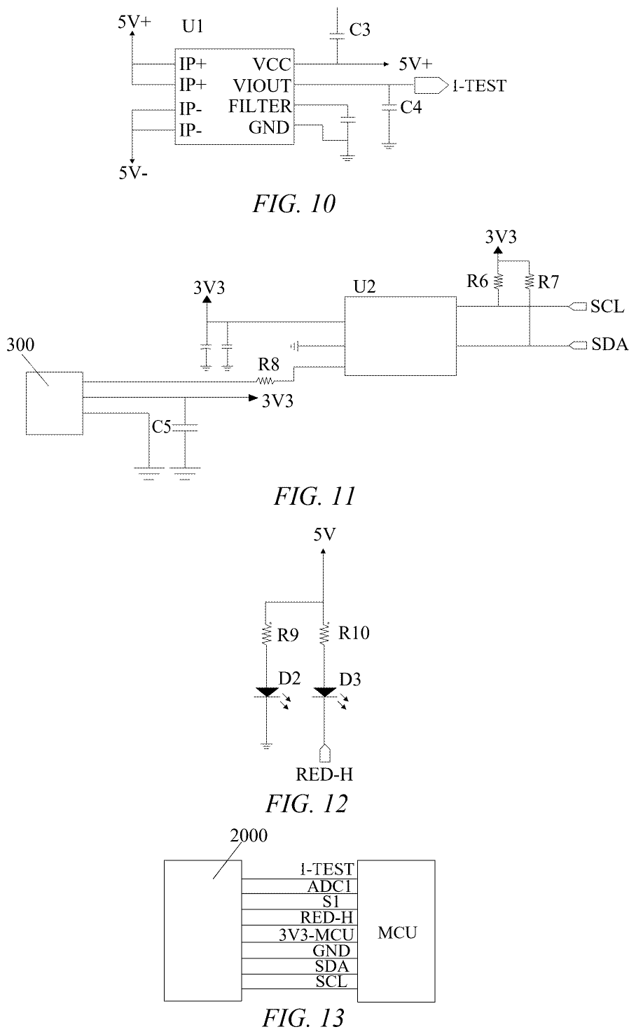

In an implementation where the position measurement component 300 is included, the measurement apparatus further includes a data acquisition module 900. As shown in FIGS. 7 and 11, an input end of the data acquisition module 900 is electrically connected to the position measurement component 300, and an output end of the data acquisition module 900 is electrically connected to the processor 500. The position measurement component 300 is configured for a movement signal, and the data acquisition module 900 is configured to output the movement distance information based on the movement signal. The data acquisition module 900 includes a second chip U2, a pull-up resistor assembly, an eighth resistor R8, and a fifth capacitor C5. A first end of the eighth resistor R8 is electrically connected to the position measurement component 300, and a second end of the eighth resistor R8 is electrically connected to an input end of the second chip U2. A first end of the fifth capacitor C5 is electrically connected to the second conversion unit 830 of the power supply module. A first end of the fifth capacitor C5 is electrically connected to a power supply end of the position measurement component 300, and a second end of the fifth capacitor C5 is grounded. An output end of the second chip U2 is electrically connected to the processor 500. The pull-up resistor assembly includes a sixth resistor R6 and a seventh resistor R7. The second chip U2 includes a first output end SCL and a second output end SDA. A first end of the sixth resistor R6 is connected to the output end of the second conversion unit 830 of a power supply module, and a second end of the sixth resistor R6 is electrically connected to the first output end SCL of the second chip U2. A first end of the seventh resistor R7 is connected to the output end of the second conversion unit 830 of the power supply module, and a second end of the seventh resistor R7 is electrically connected to the second output end SDA of the second chip U2. A power supply end of the second chip U2 is electrically connected to the second conversion unit 830. Both of the first output end SCL and the second output end SDA of the second chip U2 are electrically connected to the processor 500, and the movement signal from the position measurement component 300 is converted into a digital signal by the second chip U2. That is, the movement distance information is generated and then sent to the processor 500.

In some other implementations, the measurement apparatus further includes an indicator light module 1000. As shown in FIGS. 7 and 12, the indicator light module 1000 may include two indicator lights of different colors, such as a red indicator light and a green indicator light. For example, the indicator light module 1000 includes a first light-emitting diode D2, a second light-emitting diode D3, a ninth resistor R9, and a tenth resistor R10. A cathode of the first light-emitting diode D2 is grounded, and an anode of the first light-emitting diode D2 is connected to the first conversion unit 820 by the ninth resistor R9. The first light-emitting diode D2 is turned on and emits light which may be green when the measurement apparatus is powered on and starts to operate. A cathode of the second light-emitting diode D3 is connected to the processor 500, and an anode of the second light-emitting diode D3 is connected to the first conversion unit 820 by the tenth resistor R10. When the liquid level of the printing resin is measured to be below 30% of the highest level for the resin capacity, the processor 500 sends a control signal to turn the second light-emitting diode D3 on to emit light which may be red, to act as an indicator.

In an implementation, as shown in FIGS. 7 and 13, the measurement apparatus further includes a connecting module 2000. The connecting module 2000 is electrically connected to each of the processor 500, the level shifting circuit 610, the second conversion unit 830, the data acquisition module 900, the current measurement module 700 and the indicator light module 1000. The connecting module 2000 is configured to transmit data from the processor 500 to facilitate the level shifting circuit 610, the second conversion unit 830, the data acquisition module 900, the current measurement module 700 and the indicator light module 1000 being connected to the processor 500. The connecting module 2000 is specifically a plug board, and the processor 500 may be an MCU processor.

In another aspect, the present application further provides an additive manufacturing device, including the measurement apparatus of any one of the preceding embodiments.

The measurement apparatus is located on the base and on one side of the resin vat 10, and the first probing component 120 and the second probing component 130 of the probe assembly 100 correspond to the resin vat 10. Alternatively, the measurement apparatus may be disposed directly on the resin vat 10. The additive manufacturing device includes the measurement apparatus of any of the foregoing implementations, and includes the advantages of the measurement apparatus of any of the foregoing implementations, which will not be repeated here.

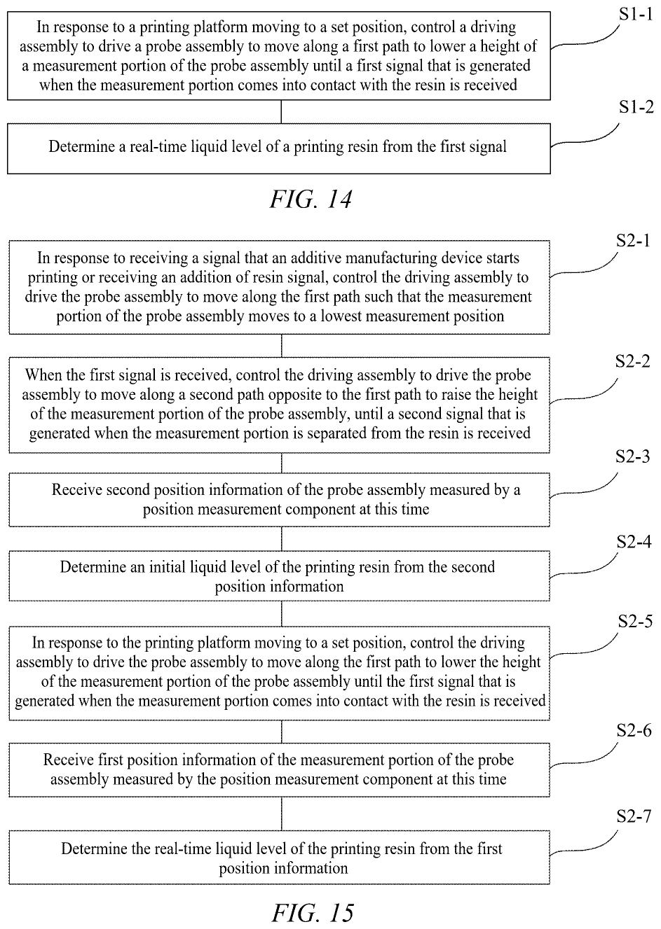

In yet another aspect, as shown in FIG. 14, the present application further provides a measurement method, including the following steps.

In step S1-1, in response to a printing platform moving to a set position, a driving assembly 200 is controlled to drive a probe assembly 100 to move along a first path to lower the height of a measurement portion of the probe assembly 100 until a first signal that is generated when the measurement portion comes into contact with the resin is received.

The set position is the height position in which the printing platform moves such that a model is separated from a liquid surface of the resin. After being raised to the set position, the printing platform can further move. On the basis that the liquid level of the resin is measured after the printing platform moves to the set position, an error in a liquid level measurement caused by the rise of the liquid surface when the printing platform is lowered can be avoided. The driving assembly 200 is configured to drive the probe assembly 100 to move along the first path under the control of the processor 500. The first path may be configured such that the probe assembly 100 vertically approaches or is rotated toward the printing resin. The rotation imparts the measurement portion a displacement component in the vertical direction, to lower the measurement portion of the probe assembly 100 such that the measurement portion can change from the state of separation from the printing resin to the state of contact with the printing resin during movement, the first probing component 120 and the second probing component 130 will change from an electrically disconnected state in which the probing components are separated from the printing resin to an electrically connected state in which the probing components are in contact with the printing resin, and the first signal is thus generated.

In step S1-2, the liquid level of the printing resin is determined from the first signal.

Depending on the type of a driving assembly 200, the movement of the probe assembly 100 varies, and the method for determining the liquid level of the printing resin from the first signal varies.

For example, in an implementation, the driving assembly 200 includes a first power component 210, the first power component 210 may be a linear servo actuator, and the linear servo actuator drives the probe assembly 100 to move in the vertical direction. In this implementation, determining the liquid level of the printing resin from the first signal includes: determining a first movement distance of the probe assembly when the first signal is generated from control information for the driving assembly, determining first position information of the probe assembly from the first movement distance, and determining a real-time liquid level of the printing resin from the first position information, that is, the real-time height of the printing resin during printing. The control information for the driving assembly is the distance information according to which the processor 500 controls the lifting and lowering of the output end of the linear servo actuator, that is, the first movement distance of the measurement portion of the probe assembly 100 in the vertical direction. The first position information of the probe assembly is determined from the start position of this movement of the probe assembly and the first movement distance, thereby obtaining the height information of the measurement portion of the probe assembly 100. The height information of the probe assembly 100 is obtained in real time during the movement of the probe assembly 100. When the processor 500 receives the first signal, the height information of the probe assembly 100 at the time of receipt of the first signal is obtained as the liquid level.

More specifically, the control information for the driving assembly includes: a number of instructions sent by the processor to the driving assembly from the start of movement of the probe assembly to the time when the first signal is generated, and a unit distance by which the probe assembly is driven to move when the driving assembly receives the instructions. Determining the first movement distance of the probe assembly when the first signal is generated from the control information for the driving assembly includes: determining the first movement distance from the number of instructions and the unit distance.

For example, the linear servo actuator converts an electrical pulse signal into a linear displacement. Upon receiving the pulse signal, a driver of the linear servo actuator drives the linear servo actuator to move a fixed linear distance in a set direction. Therefore, in an implementation, the processor 500 may calculate the movement distance of the probe assembly 100 from the number of pulses received by the linear servo actuator from the start of movement of the probe assembly 100 to the time when the signal is generated. For example, the linear servo actuator receives a control signal of 500-2500 uS (0-360° rotation) that has a period of 20 mS with a midpoint at 1500 uS, and the control signal sent to the servo actuator each time is a 10 uS adjustment signal, such that the servo actuator drives the probe assembly 100 to move vertically by 0.1 mm. The movement distance may be determined by acquiring the number of pulses that drive the linear servo actuator from the start of movement of the probe assembly 100 to the time when the signal is generated. Alternatively, in some other implementations, the linear servo actuator includes an encoder. The processor 500 is electrically connected to the encoder. Changes in a code value of the encoder are acquired from the start of movement of the probe assembly 100 to the time when the signal is generated, and the movement distance of the probe assembly 100 is calculated from the changes in the code value. For example, in an implementation, one code is equal to 0.05 mm.

In another implementation, the driving assembly 200 includes a second power component 230 for driving the probe assembly 100 to rotate. The second power component 230 may be a rotary servo actuator for driving the probe assembly 100 to rotate about its output shaft. Determining the liquid level of the printing resin from the first signal specifically includes: determining an angle of rotation of the probe assembly when the first signal is generated from control information for the driving assembly, determining a first movement distance of the probe assembly in a direction toward or away from the printing resin from the angle of rotation, determining first position information of the probe assembly from the start position of the movement of the probe assembly and the first movement distance, and determining a real-time liquid level of the printing resin from the first position information.

The height information of the measurement portion of the probe assembly 100 or the movement distance of the measurement portion in the vertical direction can be obtained from the control information and a structure of the probe assembly 100, and the height information of the measurement portion of the probe assembly 100 can be obtained from the movement distance and the initial position of the probe assembly 100. The processor 500, when receiving the first signal, calculates the current height information of the measurement portion of the current probe assembly 100 from the control information, and the real-time liquid level is determined from the height information of the measurement portion.

More specifically, the control information for the driving assembly includes: a number of instructions sent by the processor to the driving assembly from the start of movement of the probe assembly to the time when the first signal is generated, and a unit angle by which the probe assembly is driven to rotate when the driving assembly receives the instructions. Determining the angle of rotation of the probe assembly when the first signal is generated from the control information for the driving assembly includes: determining the angle of rotation from the number of instructions and the unit angle. Determining the first movement distance of the probe assembly in the direction toward or away from the printing resin from the angle of rotation includes: determining the first movement distance from the angle of rotation and a distance from the measurement portion to a center of rotation.

For example, the rotary servo actuator converts the electrical pulse signal into an angular displacement. Upon receiving the pulse signal, a driver of the rotary servo actuator drives the rotary servo actuator to rotate by a fixed angle called a “step angle” in the set direction. Thus, in an implementation, the processor 500 may calculate the angle of rotation of the probe assembly 100 from the number of pulses received by the rotary servo actuator from the start of movement of the probe assembly 100 to the time when the signal is generated. For example, the control signal sent to the servo actuator each time is a 10 uS adjustment signal such that the servo actuator drives the probe assembly 100 to rotate 0.5°, and the angle of rotation can be obtained from the number of adjustment signals sent.

Alternatively, the rotary servo actuator includes an encoder. The processor 500 is electrically connected to the encoder. Changes in a code value of the encoder are acquired from the start of movement of the probe assembly 100 to the time when the signal is generated, and the angle of rotation of the probe assembly 100 is calculated from the changes in the code value of the encoder. For example, in an implementation, one code is equal to 0.1°.

Alternatively, it is also possible to provide the rotary servo actuator with a rotation measurement component. The rotation measurement component is a combination of a magnetic scale and a magnetic reader. The magnetic scale is disposed on an output rotating shaft of the rotary servo actuator, the magnetic reader corresponds to the magnetic scale. NS-SN-NS poles of the magnetic scale generate different magnetic fields. The magnetic scale will rotate following the output rotating shaft of the rotary servo actuator during the rotation of the probe assembly 100 driven by the rotary servo actuator. The magnetic reader determines the rotation of the output rotating shaft of the rotary servo actuator by sensing the magnetic field of the magnetic scale, and the angle of rotation of the probe assembly 100 is thus obtained.

As an example, in a more specific implementation, as shown in FIG. 6, a start position of the first probing component 120 is a vertical position, and an included angle between a line connecting the measurement portion of the first probing component 120 and a center of rotation and a horizontal plane is 30°. A distance from the measurement portion of the first probing component 120 to the center of rotation is 60 mm, and a vertical distance from the measurement portion to the center of rotation in a horizontal direction is 30 mm. The angle of rotation of the probe assembly 100 is obtained from the control information, and then an included angle a (such as 10°) between the first probing component 120 and the horizontal direction may be determined, and an included angle between the line connecting the measurement portion of the first probing component 120 and the center of rotation and the horizontal plane is 30° minus 10°, i.e., 20°. From the vertical distance from the measurement portion to the center of rotation of 60 mm, the vertical distance from the measurement portion to the center of rotation in the horizontal direction may be determined to be 20.52 mm, and a difference of 19.48 mm between 30 mm and 20.52 mm is a movement height of the measurement portion.

In some other implementations, it is also possible to determine the first movement distance from the angle of rotation and preset parameters. For example, correlation information between the movement distance and the angle of rotation of the measurement portion may be directly stored in the processor 500 by ranges. For example, a range of angles of rotation correspond to a piece of distance information. The angle of rotation that is acquired may directly correspond to the distance information, i.e., obtaining an approximate height position of the probe assembly 100, which can significantly simplify the calculation by the processor.

In an implementation where the measurement apparatus includes the position measurement component 300, in step S1-2, determining the liquid level of the printing resin from the first signal specifically includes the following steps.

In step S1-2-1, the first position information of the probe assembly 100 measured by the position measurement component 300 when the first signal is generated is received.

Depending on the type of the driving assembly 200, the movement of the probe assembly 100 varies, and the first position information is obtained differently. For example, in an implementation, the driving assembly 200 includes a first power component 210, the first power component 210 may be a linear servo actuator, and the linear servo actuator drives the probe assembly 100 to move in the vertical direction. The first position information of the measurement portion of the probe assembly is determined from the movement distance of the probe assembly. In another implementation, the driving assembly 200 includes a second power component 230, and the second power component 230 may be a rotary servo actuator for driving the probe assembly 100 to rotate. The movement distance of the probe assembly 100 in the vertical direction is determined from the angle of rotation or the number of rotations of the probe assembly 100, and the first position information is thus obtained.

In step S1-2-2, the liquid level of the printing resin is determined from the first position information.

The height position of the probe assembly 100 can be obtained from the first position information. For example, the movement distance of the probe assembly is measured by the position measurement component 300, the height of the measurement portion can be obtained from the initial position and the movement distance of the probe assembly 100, and the height of the measurement portion of the probe assembly 100 is considered as the liquid level.

Further, the measurement method further includes: repeating the above steps at a preset interval time until the liquid level is below a preset lowest position.

The preset interval time can be 5 minutes, 10 minutes, etc., and can be set based on a printing speed. If the total time for printing the model is 1 hour, steps S1-1 to S1-3 can be performed every five minutes. If the total time for printing the model is 10 hours, the preset interval time can be extended, for example, steps S1-1 to S1-3 can be performed every half hour.

In some implementations, an alarm message is generated and/or the additive manufacturing device is controlled to stop printing when the liquid level is below the preset lowest position.

When the liquid level is below the preset lowest position, such as when the liquid level is at a distance of 5 mm from the release liner, the alarm message is generated and sent to a master controller. The master controller can send a prompt message through a human-machine interaction device of the additive manufacturing device or by means of an audible and visual alarm, and selection information on whether to add the resin is acquired from the human-machine interaction device. When the human-machine interaction device is a display screen, a selection interface can be displayed on the display screen to provide the prompt options of “resume printing” and “add resin”. When “resume printing” is selected from the selection information, the alarm is stopped and the printing is resumed. When “add resin” is selected from the selection information, the alarm is stopped and the resin is manually added to the resin vat 10. In addition, it is also possible to control the additive manufacturing device to stop printing when the liquid level is below the preset lowest position, so as to avoid printing failure due to insufficient resin. The additive manufacturing device can be manually activated to resume the printing after the resin is manually added. In other embodiments, it is also possible to determine the remaining amount of the printing resin from the liquid level. When the remaining amount of the printing resin is lower than a preset value, an alarm message is generated and/or the additive manufacturing device is controlled to stop printing. The remaining amount of the printing resin can be calculated from the liquid level and the size of the resin vat.

In a further aspect, as shown in FIG. 15, the present application further provides another measurement method, including the following steps.

In step S2-1, in response to receiving a signal that the additive manufacturing device starts printing or receiving an addition of resin signal, the driving assembly 200 is controlled to drive the probe assembly 100 to move along the first path such that the measurement portion of the probe assembly 100 moves to the lowest measurement position.

Receiving the signal that the additive manufacturing device starts printing may refer to that the printing platform moves to the zero position, that is, to the position that triggers a limit switch, and it may be understood that the printing platform moves to the initial position before printing, and the probe assembly 100 is moved to the lowest measurement position before the printing begins. Alternatively, in an implementation where the alarm message is generated when the liquid level is below the preset lowest position, when “add resin” is selected from the selection information, the probe assembly 100 is moved to the lowest measurement position before a user manually adds the resin to the resin vat 10.

The lowest measurement position can be a position in which the measurement portion is at a distance of 0.3 mm, 0.5 mm, etc. from the release liner, at which point the liquid level of the resin in the resin vat 10 is below the lowest level, the first probing component 120 and the second probing component 130 are in the electrically disconnected state.

In step S2-2, when the first signal is received, the driving assembly 200 is controlled to drive the probe assembly 100 to move along a second path opposite to the first path to raise the height of the measurement portion of the probe assembly 100, until a second signal that is generated when the measurement portion is separated from the resin is received.

During the addition of the resin, the liquid level in the resin vat 10 rises. Because a bottom end of the measurement portion is adjacent to the release liner, the resin will come into contact with the first probing component 120 and the second probing component 130 upon a small amount of resin is added, and the first probing component 120 and the second probing component 130 will change from the electrically disconnected state in which the probing components are separated from the printing resin to the electrically connected state in which the probing components are in contact with the printing resin, at which point the first signal is generated. Then, the driving assembly 200 is controlled to drive the probe assembly 100 to move in a direction away from the printing resin. When the addition of the resin is completed, the liquid level of the resin is constant and the probe assembly 100 continues moving, causing the measurement portion to be separated from the printing resin to generate the second signal. Due to differences in size accuracy of and assembly methods for parts, the distance between the measurement portion of the probe assembly 100 and the bottom of the resin vat may vary from one printer to another printer. the measurement portion of the probe assembly 100 is moved to the lowest measurement position and then raised, and the liquid level is calculated from the lowest measurement position, such that the result of the measurement may be more accurate.

In step S2-3, second position information of the probe assembly 100 measured by the position measurement component at this time is received.

Depending on the type of the driving assembly 200, the movement of the probe assembly 100 varies, and the second position information is obtained differently. For example, in an implementation, the driving assembly 200 includes a first power component 210, the first power component 210 may be a linear servo actuator, and the linear servo actuator drives the probe assembly 100 to move in the vertical direction. The second position information of the probe assembly is determined from the movement distance of the probe assembly. In another implementation, the driving assembly 200 includes a second power component 230, and the second power component 230 may be a rotary servo actuator for driving the probe assembly 100 to rotate. The movement distance of the probe assembly 100 in the vertical direction is determined from the angle of rotation of the probe assembly 100, and the second position information is thus obtained.

In step S2-4, an initial liquid level of the printing resin is determined from the second position information.

The height of the measurement portion can be obtained from the second position information of the probe assembly when the second signal is generated, and then the liquid level of the printing resin after the addition of resin can be obtained and can be displayed by human-machine interaction, so as to allow the user to determine whether the resin is sufficient or not. The user can continue to add the resin or stop adding, so as to accurately quantify the amount of resin to be added. And, by the measurement portion of the probe assembly 100 moving to the lowest measurement position and then rising to obtain the liquid level of the resin, the influences of the differences in size accuracy of and assembly methods for the parts can be eliminated, and the accuracy of measurement of the initial liquid level and real-time liquid level can be improved.

In step S2-5, in response to the printing platform moving to a set position, the driving assembly is controlled to drive the probe assembly to move along the first path to lower the height of the measurement portion of the probe assembly until the first signal that is generated when the measurement portion comes into contact with the resin is received.

Upon that the initial liquid level of the printing resin after the addition of resin is obtained, the printing process can be started, or the printing process can be started at the user's selection.

In step S2-6, first position information of the measurement portion of the probe assembly measured by the position measurement component at this time is received.

In step S2-7, the real-time liquid level of the printing resin is determined from the first position information. In other embodiments in which no measurement component is provided, the movement distance of the probe assembly in the vertical direction can also be determined from the control information for the driving assembly and the first signal, and the liquid level of the printing resin can be determined from the movement distance.

In still yet another aspect, the embodiments of the present application further provide an additive manufacturing device, including a processor and a memory storing a computer-executable code, wherein the processor is configured to execute the computer-executable code to implement the aforementioned measurement method.

Based on such an understanding, the technical solutions of the present application may be embodied in the form of a software product. The software product to be identified may be stored in a non-volatile storage medium (which may be a CD-ROM, a USB flash drive, a removable hard disk, etc.), and includes a plurality of instructions to cause a computer device (which may be a personal computer, a server, a network device, etc.) to perform the methods in various application scenarios of the present application.

The foregoing descriptions merely relate to the specific implementations of the present application, but the scope of protection of the present application is not limited thereto. Any changes or replacements that can be easily conceived by those skilled in the art within the technical scope disclosed by the present application shall fall within the scope of protection of the present application. Therefore, the scope of protection of the present application shall be subject to the scope of protection of the claims.

1. A measurement apparatus for use in an additive manufacturing device, comprising:
a probe assembly comprising a measurement portion and configured for electrical connection to a processor of the additive manufacturing device, the probe assembly being configured to generate and transmit a signal to the processor when the measurement portion comes into contact with and/or is separated from a printing resin; and
a driving assembly configured for electrical connection to the processor of the additive manufacturing device, the probe assembly being also connected to the driving assembly for driving the probe assembly to move under a control of the processor, so as to adjust a height position of the measurement portion, the probe assembly comprising a first probing component and a second probing component, and the measurement portion comprising an end of the first probing component and an end of the second probing component;
wherein the processor is configured to determine a liquid level of the printing resin from the signal.

2. The measurement apparatus according to claim 1, wherein
the driving assembly comprises a first power component, and the first power component is drivingly connected to the probe assembly; wherein
the first power component is configured to drive the probe assembly to move linearly; or
the driving assembly comprises a second power component; wherein
the second power component is drivingly connected to the probe assembly; and the second power component is configured to drive the probe assembly to rotate to adjust the height position of the measurement portion.

3. The measurement apparatus according to claim 1 or 2, further comprising:
a position measurement component, the position measurement component being electrically connected to the processor and configured to measure position information of the probe assembly and transmit the position information to the processor, such that the processor determines the liquid level of the printing resin from the signal and the position information; and
a base configured for connection to the additive manufacturing device, both of the driving assembly and the position measurement component being connected to the base.

4. The measurement apparatus according to claim 3, wherein the base comprises a support frame and a fixing plate connected to the support frame, the fixing plate being perpendicular to the support frame;
the driving assembly is connected to the fixing plate, an output end of the driving assembly protrudes from a top end of the fixing plate, and the probe assembly is connected to the output end;
the position measurement component is fixed to a side of the fixing plate away from the driving assembly; and
the position measurement component comprises a sensor body and a measurement head movably connected to the sensor body, one of the base and the probe assembly is connected to the sensor body, and the other of the base and the probe assembly is configured for contact with the measurement head to push the measurement head to move relative to the sensor body to generate the position information.

5. The measurement apparatus according to claim 4, wherein
the base is connected to the sensor body, and the probe assembly is configured for contact with the measurement head; and the measurement portion of the probe assembly comprises a lowest measurement position, and when the measurement portion of the probe assembly is in the lowest measurement position, the probe assembly abuts against a top end of the sensor body or the measurement head abuts against the support frame, and the measurement portion of the probe assembly abuts against or has a gap with a bottom end of a resin vat of the additive manufacturing device, the resin vat being configured to contain the printing resin.

6. The measurement apparatus according to claim 1 or 2, wherein
the probe assembly comprises a connecting plate and a probing circuit;
a first end of the connecting plate is connected to the driving assembly, a second end of the connecting plate extends toward a side away from the driving assembly, the first probing component and the second probing component are connected to the connecting plate, both of the first probing component and the second probing component are electrically connected to the probing circuit, and the probing circuit is electrically connected to the processor; the measurement portion comprises an end of the first probing component away from the connecting plate and an end of the second probing component away from the connecting plate;
the first probing component and the second probing component are configured to be electrically connected in contact with the printing resin or electrically disconnected out of contact with the printing resin, and the probing circuit is configured to generate the signal based on an electrical state of the first probing component and the second probing component;
the probing circuit comprises a fourth resistor and a fifth resistor;
a first end of the fourth resistor is configured for electrically connection to a power supply module of the additive manufacturing device, a second end of the fourth resistor is electrically connected to a first end of the fifth resistor, and a second end of the fifth resistor is grounded; and
the first end of the fifth resistor is also electrically connected to the first probing component, the second end of the fifth resistor is also electrically connected to the second probing component, and the first end of the fifth resistor is electrically connected to the processor.

7. The measurement apparatus according to claim 6, further comprising a drive module, the processor being electrically connected to the drive module, and the drive module being electrically connected to the driving assembly; wherein
the processor is configured to control the driving assembly to drive the probe assembly to move by the drive module;
the drive module comprises a level shifting circuit, wherein an input end of the level shifting circuit is electrically connected to the processor, and an output end of the level shifting circuit is electrically connected to the driving assembly;
the level shifting circuit is configured to perform level shifting on a first control signal sent by the processor to generate a second control signal for controlling the driving assembly;
the level shifting circuit comprises a first switch, a first resistor, and a second resistor, wherein a first end of the first switch is electrically connected to the processor and a first end of the first resistor, a second end of the first switch is electrically connected to a first end of the second resistor and the driving assembly, a second end of the second resistor is configured for electrical connection to the power supply module of the additive manufacturing device, and a control end of the first switch is electrically connected to the power supply module and a second end of the first resistor;
the drive module further comprises a driving circuit, wherein a first end of the driving circuit is electrically connected to the output end of the level shifting circuit, and a second end of the driving circuit is electrically connected to the driving assembly;
the driving circuit comprises a third resistor, a first capacitor, and a second capacitor; and
a first end of the third resistor is electrically connected to the output end of the level shifting circuit, and a second end of the third resistor is electrically connected to the driving assembly, a first end of the first capacitor is electrically connected to the second end of the third resistor, a second end of the first capacitor is grounded, a power supply end of the driving assembly is electrically connected to each of a first end of the second capacitor and the power supply module, and a second end of the second capacitor is grounded.

8. The measurement apparatus according to claim 5, further comprising a current measurement module and a power supply module; wherein
an input end of the current measurement module is electrically connected to the power supply module, a first output end of the current measurement module is electrically connected to a power supply end of the driving assembly, and a second output end of the current measurement module is electrically connected to the processor;
the current measurement module is configured to measure a supply current from the driving assembly and generate a movement-stop signal when the supply current is greater than a preset current, and the processor is configured to control the driving assembly to stop moving according to the movement-stop signal; and
the current measurement module comprises a first chip, a third capacitor, and a fourth capacitor, wherein an input end of the first chip is electrically connected to the power supply module, a first output end of the first chip is electrically connected to a first end of the third capacitor and the power supply end of the driving assembly, a second end of the third capacitor is grounded, a second output end of the current measurement module is electrically connected to a first end of the fourth capacitor and the processor, and a second end of the fourth capacitor is grounded.

9. An additive manufacturing device, comprising the measurement apparatus according to any one of claims 1-8.

10. A measurement method for the measurement apparatus according to any one of claims 1-8, comprising:
in response to a printing platform moving to a set position, controlling the driving assembly to drive the probe assembly to move along a first path to lower a height of the measurement portion of the probe assembly until a first signal generated when the measurement portion comes into contact with the resin is received; and
determining a liquid level of the printing resin from the first signal.

11. The measurement method according to claim 10, wherein determining the liquid level of the printing resin from the first signal comprises:
determining a first movement distance of the probe assembly when the first signal is generated from control information for the driving assembly, determining first position information of the probe assembly from the first movement distance, and determining a real-time liquid level of the printing resin from the first position information.

12. The measurement method according to claim 11, wherein
the control information for the driving assembly comprises: a number of instructions sent by the processor to the driving assembly from a start of movement of the probe assembly to a time when the first signal is generated, and a unit distance by which the probe assembly is driven to move when the driving assembly receives the instructions; and
determining the first movement distance of the probe assembly when the first signal is generated from the control information for the driving assembly comprises:
determining the first movement distance from the number of instructions and the unit distance.

13. The measurement method according to claim 10, wherein determining the liquid level of the printing resin from the first signal comprises:
determining an angle of rotation of the probe assembly when the first signal is generated from control information for the driving assembly, determining a first movement distance of the probe assembly in a direction toward or away from the printing resin from the angle of rotation, determining first position information of the probe assembly from the first movement distance, and determining a real-time liquid level of the printing resin from the first position information.

14. The measurement method according to claim 13, wherein
the control information for the driving assembly comprises: a number of instructions sent by the processor to the driving assembly from a start of movement of the probe assembly to a time when the first signal is generated, and a unit angle by which the probe assembly is driven to rotate when the driving assembly receives the instructions; and
determining the angle of rotation of the probe assembly when the first signal is generated from the control information for the driving assembly comprises:
determining the angle of rotation from the number of instructions and the unit angle.

15. The measurement method according to claim 13, wherein determining the first movement distance of the probe assembly in the direction toward or away from the printing resin from the angle of rotation comprises:
determining the first movement distance from the angle of rotation and a distance from the measurement portion to a center of rotation;
or determining the first movement distance from the angle of rotation and preset parameters.

16. The measurement method according to claim 11 or 13, wherein determining the first position information of the probe assembly from the first movement distance comprises:
determining the first position information of the probe assembly from a start position of a movement of the probe assembly and the first movement distance.

17. The measurement method according to claim 10, wherein determining the liquid level of the printing resin from the first signal comprises:
receiving first position information of the measurement portion of the probe assembly measured by a position measurement component when the first signal is generated, and determining a real-time liquid level of the printing resin from the first position information.

18. The measurement method according to claim 10, wherein the above steps are repeated at a preset interval time until the liquid level is below a preset lowest position.

19. The measurement method according to claim 10, further comprising prior to controlling the driving assembly to drive the probe assembly to move along the first path to lower the height of the measurement portion of the probe assembly until the first signal generated when the measurement portion comes into contact with the resin is received:
in response to receiving a signal that the additive manufacturing device starts printing or receiving an addition of resin signal,
controlling the driving assembly to drive the probe assembly to move along the first path such that the measurement portion of the probe assembly moves to a lowest measurement position, and controlling the driving assembly to drive the probe assembly to move along a second path opposite to the first path when the first signal is received to raise the height of the measurement portion of the probe assembly, until a second signal generated when the measurement portion is separated from the resin is received; and
determining an initial liquid level of the printing resin from the second signal.

20. The measurement method according to claim 10, further comprises:
determining a remaining amount of the printing resin from the liquid level; and
generating an alarm message and/or controlling the additive manufacturing device to stop printing when the liquid level is below a preset lowest position or the remaining amount of the printing resin is lower than a preset value.

21. An additive manufacturing device, comprising a processor and a memory storing a computer-executable code, wherein the processor is configured to execute the computer-executable code to implement the measurement method of any one of claims 10-20.
